(19) United States
(12) Patent Application Publication
(10) Pub. No.: US 2007/0139207 A1
(43) Pub. Date: Jun. 21, 2007

(54) Method & system for notification of a restraining/protective order violation based on predatory patterns

(75) Inventors: Ciprian Agapi, Lake Worth, FL (US); James R. Lewis, Delray Beach, FL (US); Pradeep P. Mansey, Coral Springs, FL (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/314,395

(22) Filed: Dec. 21, 2005

(51) Int. Cl. G08B 23/00; G06N 5/02; G06F 17/18

(52) U.S. Cl. 340/573.4; 706/47; 702/180

(57) ABSTRACT

A method and system relating to a restraining or protective order violation scenario where the movements of the restrainee and the movements of the protected person are monitored in order to detect if a predatory pattern is at hand. The movement, velocity, and positioning of the restrainee can be described as a set of patterns with respect to the protected person. The patterns can be determined based upon the distance between the two, and the direction and speed of both the restrainee and the protected person. Depending on the detected pattern, a notification system incorporating the present invention alerts the local law enforcement authorities with a warning or alarm, and/or sends a warning/alarm signal to the protected person if a predatory pattern is detected.

### BACKGROUND OF THE INVENTION

1. Field of the Invention

The present invention relates to the field of restraining and protective orders and more particularly to a system and method of analyzing and correlating the movements, velocities, and relative positioning of both the restrainee and the protected person in order to determine if a valid predatory pattern exists to identify a potential restraining or protective order violation.

2. Description of the Related Art

Protective or restraining orders are often issued in cases of domestic abuse, when there is a high likelihood that the victim will be abused again. Stalkers who harass their victims can also receive protective orders if there is a high likelihood that further stalking may ultimately lead to violence. In recent studies however, almost 81 percent of stalkers violate the order and in approximately 21 percent of cases, violence and stalking escalate after the protective order is issued.

Once a restraining or protective order has been violated, there are usually steps taken to monitor the movements and whereabouts of the restrainee. For example, one type of system uses electronic bracelets to monitor the movements of the restrainee. While electronic bracelets may be somewhat effective in the case of in-house arrests, providing information about when the restrainee left or returned to a location within a restrictive perimeter, they don't transmit any information about their whereabouts outside of the restricted area.

Other systems used to supplement restraining orders are tracking devices with GPS capabilities, worn by the restrainee. These devices have the capability to send location information to a notification system linked to both an enforcement agency and to the protected person. The notification system has knowledge of the protected person's location (for example through their GPS-enabled cell phone) and can calculate a perimeter around the protected person. If the restrainee moves within the perimeter, the system can notify authorities in order to apprehend the restrainee, and also notify the protected person to take protective measures. However, these systems do not take into consideration false alarms due to accidental encounters, or valid alarms due to pattern matching in the movement of the protected person and the restrainee.

There is currently no restrainee tracking or monitoring system that continuously reports the location of the restrainee and determines the existence of predatory patterns relating to the relative positioning of the restrainee and the protected person. It is therefore desirable to have a method and system that detects a pattern in the movement of the restrainee correlated with the movement of the protected person and that alerts the protected person and/or the authorities if the correlated movements represent a potentially dangerous encounter.

### BRIEF SUMMARY OF THE INVENTION

Embodiments of the present invention address the deficiencies of the art in respect to restraining orders and restrainee monitoring systems and provides a novel and non-obvious method and system for receiving positional information from a restrainee and a protected person, and based upon this information, determining if a predatory pattern is present. A monitoring station continuously receives positional information from a restrainee and a protected person via an electronic geographic positioning system such as a GPS system. A computer analyzes the positional information, and compares the results to a stored set of rules in order to determine if one or more predatory patterns exist. Depending upon which pattern is identified, the monitoring station transmits a warning signal to the protected person via his or her personal communication device such as a cellular phone or a PDA. The monitoring station may also transmit an alarm signal to the local law enforcement authorities.

In one embodiment, a system for identifying predatory patterns based on movement and proximity correlations between a predator and a victim is provided. The system includes a monitoring facility adapted to continuously receive positional information from the predator and the victim for a given time period. The monitoring facility includes a computer system adapted to identify correlations between position and movement of the predator and the victim and to determine the existence of predatory patterns based upon the correlations. The monitoring facility also includes signaling means for alerting the victim if the computer system determines the existence of the predatory pattern.

In another embodiment, a method of identifying predatory patterns based on movement and proximity correlations between a predator and a victim is provided. The method includes continuously receiving positional information from the predator and the victim for a given time period, identifying correlations between position and movement of the predator and the victim, determining the existence of one or more predatory patterns based upon the correlations, and transmitting a warning signal upon determination of the existence of one or more of predatory patterns.

In yet another embodiment, a computer program product comprising a computer usable medium having computer usable program code for identifying predatory patterns based on received positional information from the predator and the victim is provided. The computer program product includes computer usable program code for identifying correlations between position and movement of the predator and the victim, and computer usable program code for determining the existence of one or more predatory patterns based upon the correlations.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an illustration of a restrainee monitoring system in accordance incorporating features of the present invention;

FIG. 2 is a flow chart illustrating a notification process for determining whether an emergency pattern exists based upon the protected person and the restrainee's movements;

FIG. 3 is a movement grid illustrating under which circumstances movement of the protected person and restrainee establish an accidental encounter pattern, in accordance with an embodiment of the present invention;

FIGS. 4 is a movement grid illustrating under which circumstances movement of the protected person and restrainee establish an ambush pattern, in accordance with an embodiment of the present invention;

FIGS. 5a and 5b are movement grids illustrating under which circumstances movement of the protected person and restrainee establish a surveillance pattern, in accordance with an embodiment of the present invention;

FIG. 6 is a movement grid illustrating under which circumstances movement of the protected person and restrainee establish an attack pattern, in accordance with an embodiment of the present invention; and

FIG. 7 is a flow chart illustrating under which circumstances alerts are issued in accordance with an embodiment of the present invention.

### DETAILED DESCRIPTION OF THE INVENTION

Embodiments of the present invention provide a method and system relating to a restraining or protective order violation scenario where the movements of the restrainee and the movements of the protected person are monitored in order to detect if a predatory pattern is at hand. The behavior of the restrainee can be described as a set of patterns with respect to the protected person or to a known geographic region or path. The patterns can be determined based upon the distance between the two parties and the direction and speed of both the restrainee and the protected person. Depending on the detected pattern, a notification system incorporating the present invention alerts the local law enforcement authorities with a warning or alarm, and/or sends a warning/alarm signal to the protected person, via their electronic communications device, such as a cellular phone. The warning signal received by the protected person may automatically display a map with the location of the restrainee and the direction the restrainee is presently taking.

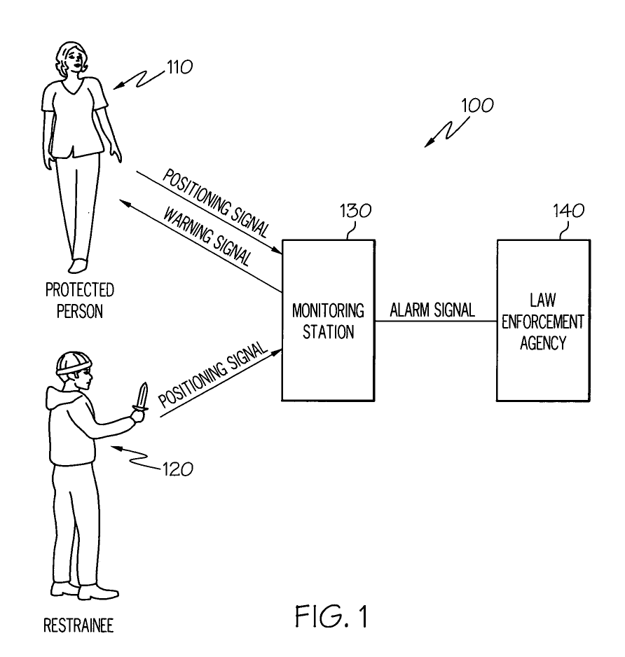

In further illustration, FIG. 1 is a diagram illustrating a restrainee monitoring and alarm system 100 in accordance with the present invention. System 100 is configured to receive positioning signals from a protected person PP 110 via any electronic positioning and communication device known in the art, such as a Global Positioning System (GPS) device. In similar fashion, positioning signals are also received from a restrainee R 120, via a GPS or similar positioning device. The terms “protected person” and “restrainee” are given to persons typically involved in disputes that have given rise to restraining or protective orders (the terms “victim” and “predator”, respectively, will be used interchangeably with these terms). However, the present invention is not limited to use in this scenario, and may be applied to any scenario where the movements of two or more people are to be correlated and monitored.

A monitoring station 130 receives the positioning signals from protected person PP 110 and restrainee R 120 and constructs positioning correlation tables in accordance with the present invention to determine if a predatory pattern exists. A predatory pattern may be defined as any situation where the relative positioning of the two parties creates a potentially dangerous situation to PP 110 due to the relative proximity of R 120.

Monitoring station 130 may include a computer system having a database and a central processing unit (CPU), one or more memory devices, and associated circuitry. The CPU can be comprised of any suitable microprocessor or other electronic processing unit, as is well known to those skilled in the art. Monitoring station 130 also includes an antenna with the capability of receiving GPS positional signals from PP 110 and R 120, and a transmitter for transmitting warning signals to PP 110 and/or a law enforcement agency 140. The warning signal to PP 110 and/or agency 140 may also include a pictorial representation (i.e., a map) of the current position of R 120 and his or her current direction of movement.

If a particular predatory pattern is determined to exist, monitoring system 130 transmits an alarm or warning signal to law enforcement agency 140 and/or PP 110. The warning signal may be received by PP 110 via their cellular phone, land-line phone, GPS device, PDA, PC and/or any electronic communications device capable of receiving electronic signals and/or displaying pictorial information.

The monitoring station 130 receives GPS positioning signals from PP 110 and R 120 and creates a correlation table listing the current position and movement of each individual. The position of each party is constantly updated as positional information is received. By utilizing correlation algorithms, station 130 is able to determine if a predatory pattern exists. In some instances, no predatory pattern exists because PP 110 and R 120 display a mere random pattern of movement. When there is no correlation in the distance between PP 110 and R 120, the direction each are traveling in with respect to each other, or the speed each is moving, the monitoring station 130 determines that each party is moving in a random manner and no predatory pattern exists.

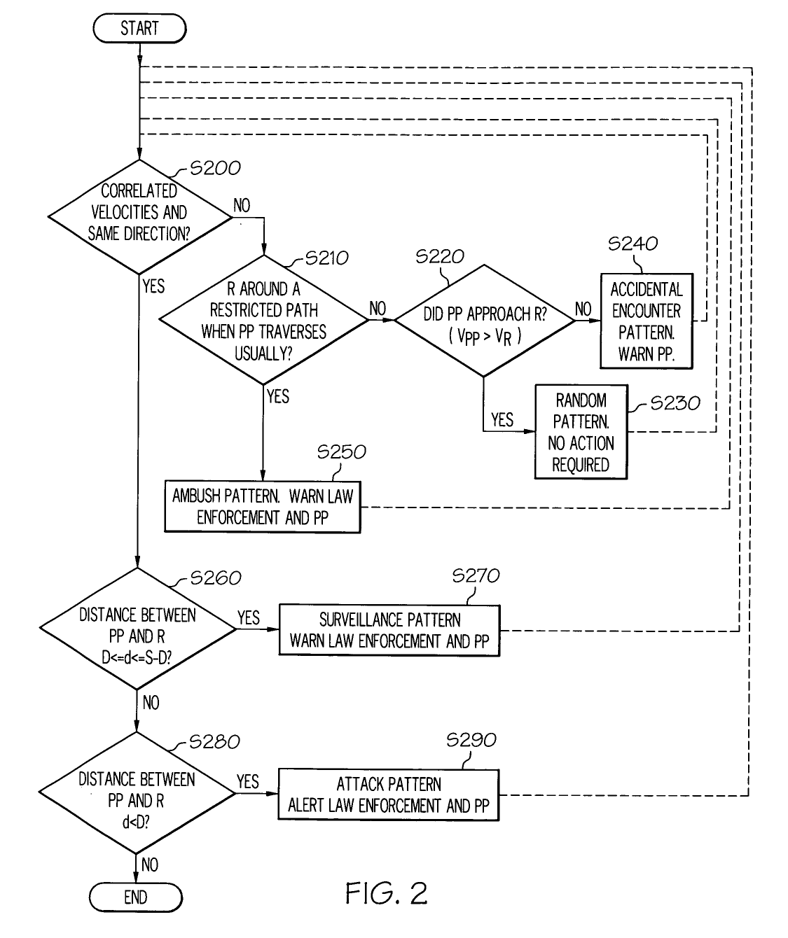

FIG. 2 is a flow chart illustrating a correlation process used by the present invention to determine if a predatory pattern exists. Monitoring station 130 receives the velocities and directional movement of both PP 110 and R 120 and determines if there exists any correlation among this information, at step S200. Station 130 also stores information regarding the usual whereabouts of PP 110, i.e., areas where PP 110 is likely to traverse. These areas may include his or her place of work, a child's school, the local playground, a supermarket, a friend's house or a physical fitness center. Station 130 determines if R 120 is within a predetermined distance of any of these areas, at step S 210. If not, it is then determined if PP 110 approached R 120, or R 120 approached PP 110, via step S220. By analyzing the relative movements of the two parties, station 130 determines if PP 110 approached R 120, therefore making it less likely that PP 110 is being “stalked” by R 120.

One method of determining whether the close proximity of R 120 and PP 110 is a random event or something more threatening, is to analyze and compare the movement velocities of both PP 110 and R 120. If V_{PP} represents the velocity of PP 110 and V_{R} represents the velocity of R 120, and V_{PP} is greater than V_{R}, it can be generally concluded that PP 110 is not in danger due to the slower velocity of R 120 with respect to PP 110. In this situation, station 130 concludes that the movement pattern of each party relative to each other is random, and no action is required, at step S230.

An example of a “random” movement pattern is when R 120 gets close to PP 110 momentarily but then moves away. When close to PP 110, R 120 represents a temporary threat, but the present invention analyzes the continued movement and positional signals of R 120 before concluding that a predatory pattern exists and a warning is send out. If the received positional signals continue to indicate that the distance between R 120 and PP 110 is increasing and continues in this fashion, the system determines that the previous encounter was random. In this instance, a warning signal should not be transmitted. If a warning alert had already been transmitted due to the initial proximity between R 120 and PP110, but it is subsequently determined that a random pattern exists, the system, either automatically through the use of speech recognition or by a human agent using techniques that are well known for home alarm systems, can contact P 110 to get authorization to cancel the alert.

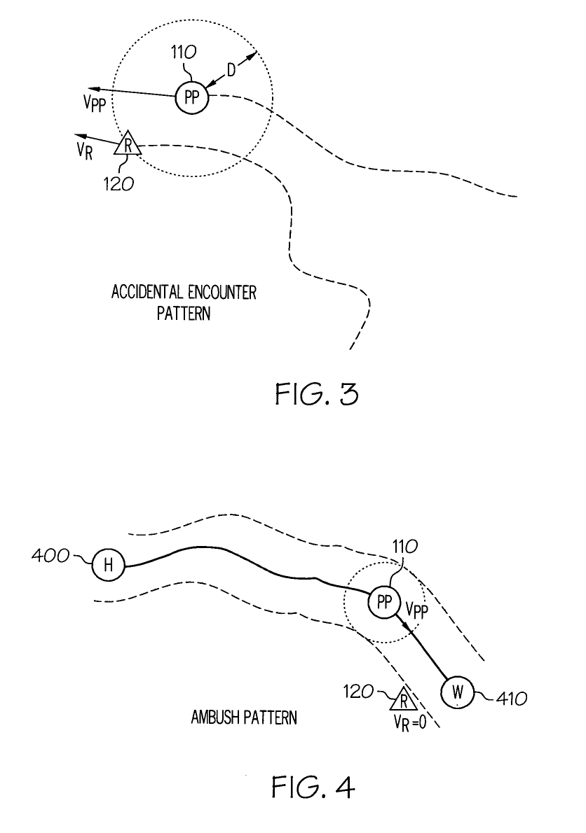

However, if the system determines that R 120 is within a certain distance of PP 110, an encounter, whether innocent (i.e. “accidental”) or premeditated, may exist. FIG. 3 provides an illustration of the relative movements of PP 110 and R 120 during an accidental encounter. It should be noted that an accidental encounter (as well as other predatory patterns defined herein) can be defined in any number of ways. That is, the criteria used to define a predatory pattern can be fine-tuned by the system designer.

For example, an accidental encounter may be defined as a pattern where R 120 is stationary or moving ahead of PP 110. The pattern in FIG. 3 shows PP 110 moving in one direction and at a particular speed as indicated by the vector “V_{PP}”. R 120 is moving in the direction of vector “V_{R}” at a particular speed. In an accidental encounter pattern, either the velocity of R 120 is less than the velocity of PP 110, meaning R 120 is traveling slower than P 110, or, R 120 is stationary (i.e., V_{R}=0). In either case, R 120 has moved within a radius D, which is a pre-determined “restrictive” distance or zone around PP 110. Thus, although the distance d between R 120 and PP 110 may be less than distance D, because R 120 is positioned ahead of PP 110 and is either stationary or traveling at a velocity slower than PP 110, the encounter is considered “accidental” and is not considered a predatory pattern. In this scenario, no alarm is transmitted to local authority 140, but a warning signal may be sent to PP 110 to undertake one or more evasive actions.

Thus, in an accidental encounter situation, the present invention recognizes the situation is one that does not give rise to an emergency. That is, although R 120 is within the “restrictive zone” of PP 110, the fact that R 120 is in front of PP 110 and either not moving at all, or moving slowly (as compared to the velocity of PP 110), indicates in all likelihood that the proximity between the two was merely fortuitous and not intentional.

Returning to FIG. 2, step S210 determines if R 120 has traveled within a restricted path that PP 110 usually traverses. If this has occurred, an ambush pattern may exist, in which case law enforcement agency 140 and PP 110 are warned, at step S250. FIG. 4 provides a more detailed illustration of an ambush pattern. In FIG. 4, an ambush pattern occurs when R 120 is waiting in the proximity of the work location 410 of PP 110. The path depicted in FIG. 4 is the trajectory PP 110 takes from one location, i.e., home 400 to another location such as work 410.

An ambush pattern occurs in locations where R 120 has an apriori knowledge that PP 110 will traverse at certain times. In this pattern, R 120 is quasi-stationary (V_{R}=0, or is close to 0) with respect to a well-known destination location (W) 410 of PP 110 or could be moving along a defined buffer zone. A well-known path of PP 110 could be for example, from home (H) 400 to work (W) 410, from home (H) 400 to the child's school, or to the supermarket, etc. Monitoring system 130 can configure and store the well-known paths according to a set of pre-defined rules, and buffer zones can be assigned such that R 120 cannot cross them.

Thus, in the case of an ambush pattern, the movements of R 120 with respect to a destination or a specific path often traveled by PP 110 are monitored, rather than the relative movements between PP 110 and R 120. By monitoring R's movements with respect to a location that is often frequented by PP 110 or a path that is often traveled by PP 110, the present invention addresses deficiencies in the art by recognizing that even when the GPS positional signals of each party do not necessarily place them in close proximity with one another, a potential emergency situation may still exist due to the proximity of R 120 in relation to a known geographic location or route. In the case of an ambush pattern, a warning signal is sent to both PP 110 and law enforcement agency 140 warning each of the emergency situation that is unfolding.

In one embodiment, the system determines that R 120 is not moving, but remains on the path that PP 110 is currently traveling on. Thus, while prior art systems might not recognize the existence of a predatory pattern because R 120 is not moving, the present invention recognizes an ambush pattern, since R 120 is proximate an oft-used path of PP 110 and the distance between PP 110 and R 120 is decreasing despite the fact that R 120 is stationary (i.e., PP 110 is walking toward the stationary R 120).

In another embodiment, the system might detect back-and-forth movements by R 120. This may indicate that R 120 is pacing, while lying in wait for PP 110. Thus, in the event of an ambush pattern, the present invention takes into account the movement of R 120 with respect to not only PP 110, but to paths often traveled by PP 110, paths currently being traveled by PP 110, and geographic regions frequented by PP 110.

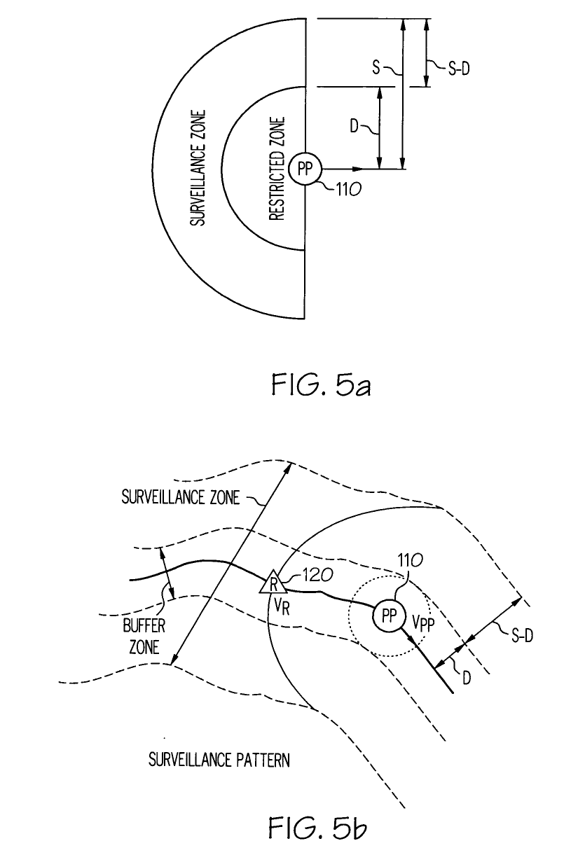

FIGS. 5a and 5b represents a movement map whereby the relative movements of PP 110 and R 120 result in a surveillance or following pattern. A surveillance pattern occurs when the direction of movement of PP 110 and R 120 is similar, and there is a strong correlation between the velocities of PP 110 and R 120 over a period of time. As a result, the distance “d” between PP 110 and R 120 is constant or quasi-constant, and R 120 moves in a C-shaped surveillance zone behind PP 110. The surveillance zone can be defined as an area delineated by a semicircle with radius S, and a restricted area with radius D, behind PP 110.

In FIG. 5a, a distance D represents a restricted area behind PP 110, as PP 110 travels in the direction of the arrow. If R 120 is within surveillance zone S, and R's position remains constant or semi-constant with respect to PP110, a surveillance pattern may exist. In a surveillance pattern, R 120 is behind PP 110 at a certain distance, and this distance remains quasi-constant. In reality, this may represent a stalker R 120 keeping his distance from PP 110, by not falling too far behind, yet not gaining ground on PP 110 where PP 110 may notice R 120. Thus, if R 120 falls within restricted area D, a different predatory pattern may be recognized.

In FIG. 5b, the relative position and movement of R 120 are more clearly seen. R 120 maintains a position behind PP 110, somewhere between D (restricted area) and S-D (the difference between the surveillance area and the restricted area). Over time, as the relative positional signals of PP 110 and R 120 received by station 130 remain constant, under the “surveillance” guidelines described above, a surveillance pattern is detected, and warning signals sent out to agency 140 and/or PP 110.

An example of a surveillance or “following” pattern is when PP 110 and R 120 are on the same path, but R 120 is behind P 110 at a certain distance. While many prior art systems would not recognize this pattern as a predatory pattern since the distance between R 120 and PP 110 may not fall within the “critical” range, the present invention recognizes this as a potential surveillance pattern. Thus, a surveillance pattern may be detected when both R 120 and PP 110 are in motion along a similar path, but the distance between the two is quasi-constant and does not approach zero.

Another example of a surveillance or following pattern is when R 120 and P 110 are not traveling along the same path, but, rather, R 120 is traveling along a path substantially parallel to the path P 110 is traveling. Again, the distance between R 120 and P 110 is quasi-constant and is not approaching zero. However, the correlation between each party's movement, velocity, and relative proximity to each other provide a scenario where the R 120 may be following P 110 at a distance so as not to be seen by P 110.

Returning once again to FIG. 2, step S260 determines the distance between R 120 and PP 110. Specifically, if R 120 maintains a distance “d” behind PP 110 that is greater than or equal to the restricted zone D and less than or equal to the difference between the surveillance zone and the restricted zone (S-D), then a surveillance pattern is identified, and warning/alarm signals are sent out to one or both of PP 110 and agency 140, at step S270. If, however, the distance “d” between R 120 and PP 110 is within the restricted zone D, then R 120 has “closed in” on PP 110 and an attack pattern exists, as determined by step S280. As will be discussed in greater detail below with respect to the attack pattern, agency 140 and PP 110 are notified at once, at step S290.

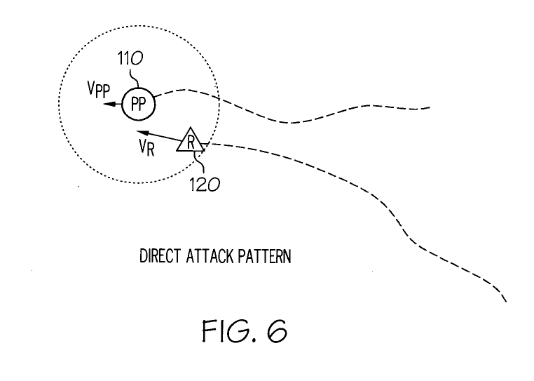

FIG. 6 is a movement map illustrating the relative movement and positioning of R 120 and PP 110 in a direct attack pattern. In a direct attack pattern, the distance d between R 120 and PP 110 is less than distance of the restricted zone D and is diminishing with time. Although the direction of movement of R 120 and PP 110 may be similar, the velocity of R 120 (V_{R}) is greater than the velocity of PP 110 (V_{PP}). An attack scenario is one where the restrainee R 120, approaches the protected person PP 110, enters their “protective” zone, and then picks up speed and moves, or even runs, toward PP 110.

A direct attack that is a premeditated attack is typically preceded by an ambush or a surveillance pattern, as that pattern is described above. A direct attack that is a spontaneous attack is typically preceded by an accidental encounter pattern, as that pattern is described above. In a direct attack scenario, whether premeditated or spontaneous, an alarm is sent to both the PP 110 and the law enforcement agency 140.

An example of an attack pattern is when P 110 is moving along a specific path and R 120 is along the same path but traveling at a greater speed, such that the distance between R 120 and PP 110 is decreasing with time, with the presumption being that R 120 will ultimately overtake PP 110. In another embodiment, R 120 is on the same path as PP 110, but is traveling in the opposite direction. In other words, R 120 is directly advancing toward PP 110. In yet another example, R 120 is on a path that is orthogonal to the path traveled by PP 110. In this scenario, the likely result is that R 120 attacks PP 110 by intercepting PP 110 along the path. In still another example of an attack pattern, PP 110 is stationary and R 120 is on a path that leads directly to PP 110. It is contemplated that other attack patterns, as well as other predatory patterns may be defined and incorporated into system 100.

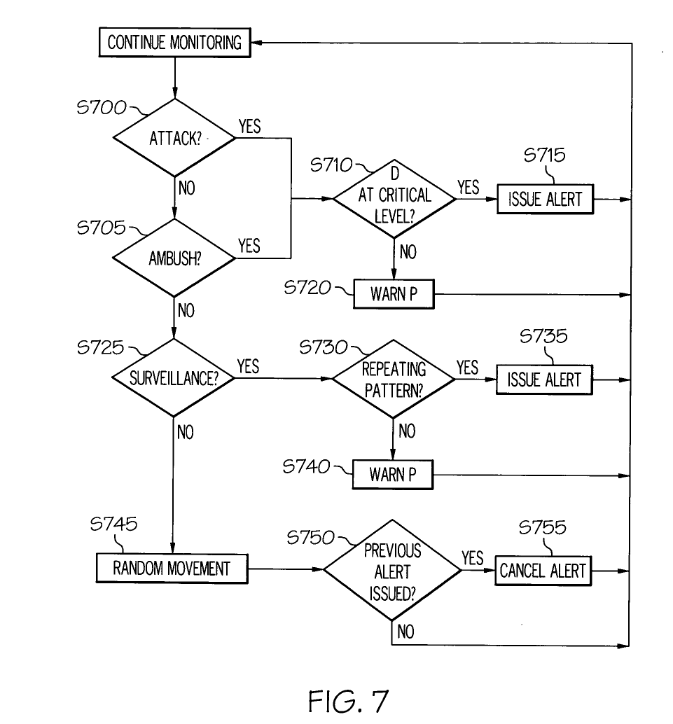

FIG. 7 is a flow chart illustrating under which circumstances alerts are issued in accordance with one embodiment of the present invention. In this embodiment, monitoring station 130 determines if an attack pattern or ambush pattern is presented, via steps S700 and step S705, respectively, in a manner described above. If either pattern is detected, station 130 determines if the distance d between R 120 and PP 110 is “critical”, via step S710. This level of criticality can be accomplished in any number of ways.

For example, using a Cartesian coordinate system, perhaps superimposed over a map, positional data representing relative distances of R 120 and PP 110 can be plotted. A sample number of positional reference points, for example between 4 to 10, can be used to determine if there is a correlation between the movements of R 120 and PP 110, i.e., is R 120 gaining ground on PP 110, lying in wait for PP 110, or moving away from PP 110. Of course, any number of sample points may be used to provide an adequate statistical base.

Once these points have been plotted and analyzed, station 130 determines whether the value d between R 120 and PP 110 has reached a level worthy of issuing a warning to PP 110 (medium level of criticality) but has not reached a high level of criticality, which would prompt station 130 to issue a warning alarm to agency 140. As distance d approaches 0, an imminent ambush or attack scenario can be identified. The movement of R 120 is taken into account as well, i.e., if R 120 is in motion or if R 120 is stationary. If the distance d remains the same after several readings, or even increases, this might be an indication that the situation has stabilized (indicating a potential following behavior).

If a processor at station 130 detects a potential ambush or attack behavior, station 130 can issue a preliminary warning to PP 110 (copied to the appropriate law enforcement agency to keep a record), followed by a request to agency 140 for police assistance and instructions for evasive actions to PP 110 if distance d falls below a critical level. The “level of criticality” used to make the determination if and when to send an alarm signal to PP 110 and/or agency 140 is programmable and can be adjusted for different situations. For example, in instances where a restrainee RR 120 has previously violated his restraining order, critical distance d may be programmed to be of a higher than “normal”. Thus, the “level of criticality” is reached sooner.

In another example, the criticality criterion is based on prior behavior of R 120. Thus, a request for police assistance can be dependent upon whether R 120 has a history of following PP 110 (for example, R 120 has followed PP 110 for X number of times in the last T time period). If an alert has been issued, but the system then detects that R 120 is moving away from PP 110, the system can have the police (or an agency similar to those that monitor house alarms) contact PP 110 and request a code word that will let PP 110 cancel the alert.

Returning to FIG. 7, if the distance d between R 120 and PP 110 is considered critical, then an alert is issued to agency 140, at step S715. If the distance is not considered critical, then a warning may be issued to PP 110, at step S720. Although an attack or ambush pattern may not been detected, the movements of R 120 and PP 110 may describe a following, or surveillance pattern, at S725.

The present invention can utilize one or more of any number of well known data correlation methods in order to determine predatory patterns between one or more restrainees and one or more protected persons. For example, the relative distance between R 120 and PP 110 can be measured by plotting positional data along Cartesian coordinates. By utilizing well-known methods of discriminate analysis using multivariate statistics, the measurements can be used to create a discriminate model for the different patterns and scenarios recognized by the inventive system, i.e., accidental occurrence, surveillance, ambush, attack etc.

It is within the scope of the invention to incorporate any well known guidelines for interpreting the strength of correlations. One example is to provide a ranking system for different correlation levels. For example, a “Low” level might represent correlations with an absolute value less than 0.3), a “Moderate” level might represent correlations having a correlation range from 0.3 to 0.6, and a “High” level might apply to a correlation having an absolute value greater than 0.6. In some situations, for example, when there is no variance in one of the variables, the correlation will be labeled as “Undefined”. Further, it is possible to use either discrete (even categorical) variables (e.g., Low, Medium, and High) and continuous variables, or any combination of categorical, discrete, and continuous variables in discriminate models.

In another embodiment, when enrolling in a system incorporating the invention, the protected person PP 110, defines one or more routes and the times when he or she travels those routes (e.g., going to and from work). In addition to monitoring the positional relationship between R 120 and PP 110, the system could also monitor the relationship between R 120 and the stored routes of PP 110. For example, suppose that at the time PP 110 normally travels to work, the system detects R 120 waiting at a point on the route between PP 110 and their work destination. This could provide a basis for issuing a low-level alert when the distance between R 120 and PP 110 would otherwise not be close enough to cause the system to issue an alert.

When P 110 is notified of a potential danger due to an identified predatory pattern, the system of the present invention may also provide evasive directions that PP 110 may use to avoid a potential dangerous situation. The invention uses known evasive techniques associated with redirecting traffic from problem areas. Thus, the system can inform PP 110 where R 120 is presently located, and specific directions as to where PP 110 can move to in order to avoid R 120.

The present invention is also not limited in the type of positional information that it receives in order to determine the existence of predatory patterns. For example, in addition to receiving the velocity of R 120 and PP 110, monitoring station 130 could also receive information regarding the rates of change of the velocity of R 120 and PP 110 over time, i.e. the acceleration of R 120 and PP 110. By incorporating each party's acceleration into the formulation, system 100 can recognize situations where R 120 accelerates after spotting PP 110. Warning signals can thus be generated and sent to PP 110 once it has been determined that R 120 has accelerated toward PP 110.

Returning to FIG. 7, if the system 100, at step S725, determines that a surveillance or following pattern exists, and the pattern has occurred before, i.e. is a repeating pattern, as determined by step S730, an alert is sent out to agency 140 and PP 110, via step S735. In one embodiment, if the surveillance pattern has not occurred before, as determined by step S730, system 100 issues a warning signal only to PP 110, at step S740. If a surveillance pattern has not been detected, the movements of R 120 and PP 110 may be considered to be random, as determined by step S745. If PP 110 had already received a warning signal from monitoring station 130, as determined by step S750, then the warning can be canceled, via step S755, by transmitting a subsequent signal to PP 110 informing them that the previous signal was erroneous and the movements of R 120 and PP 110 created a mere random encounter.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A system for identifying predatory patterns based on movement and proximity correlations between a predator and a victim, the system comprising:
a monitoring facility adapted to continuously receive positional information from the predator and the victim for a given time period, the monitoring facility including:
a computer system adapted to identify correlations between position and movement of the predator and the victim and to determine the existence of one or more predatory patterns based upon the correlations; and
signaling means for alerting the victim if the computer system determines the existence of one or more predatory pattern.

2. The system of claim 1, wherein the positional information includes at least the direction of movement, and the velocity of the predator and the victim, and the relational positioning between the predator and the victim.

3. The system of claim 1, wherein the monitoring facility further includes signaling means for alerting a law enforcement agency if the computer determines the existence of a predatory pattern.

4. The system of claim 2, wherein an accidental encounter exists if:
the predator moves within a restricted distance of the victim;
there is no correlation between the direction of movement and the velocity of the predator and the direction of movement and the velocity of the victim; and
the predator is not near a geographic region or path known by the victim, whereby an accidental encounter does not give rise to a predatory pattern.

5. The system of claim 2, wherein a surveillance pattern exists if there is a correlation between the direction of movement and velocity of the predator and the direction of movement and velocity of the victim even if the predator is not within a restricted distance of the victim.

6. The system of claim 1, wherein an ambush pattern exists if the predator is substantially stationary for an extended period of time with respect to a geographic region or path known by the victim.

7. The system of claim 1, wherein an attack pattern exists if the distance between the predator and the victim is less than a pre-determined distance and is decreasing with time, and the predator is moving with a greater velocity than the victim.

8. A method of identifying predatory patterns based on movement and proximity correlations between a predator and a victim, the method comprising:
continuously receiving positional information from the predator and the victim for a given time period;
identifying correlations between position and movement of the predator and the victim;
determining the existence of one or more predatory patterns based upon the correlations; and
transmitting a warning signal upon determination of the existence of one or more predatory pattern.

9. The method of claim 8, wherein the warning signal can be transmitted to at least the victim and a law enforcement agency.

10. The method of claim 8, wherein the positional information includes at least the direction of movement, and the velocity of the predator and the victim, and the relational positioning between the predator and the victim.

11. The method of claim 10, wherein an accidental encounter exists if:
the predator moves within a restricted distance of the victim;
there is no correlation between the direction of movement and the velocity of the predator and the direction of movement and the velocity of the victim; and
the predator is not near a geographic region or path known by the victim, whereby an accidental encounter does not give rise to a predatory pattern.

12. The method of claim 10, wherein a surveillance pattern exists if there is a correlation between the direction of movement and velocity of the predator and the direction of movement and velocity of the victim even if the predator is not within a restricted distance of the victim.

13. The method of claim 10, wherein an ambush pattern exists if the predator is substantially stationary for an extended period of time with respect to a geographic region or path known by the victim.

14. The method of claim 10, wherein an attack pattern exists if the distance between the predator and the victim is less than a pre-determined distance and is decreasing with time, and the predator is moving with a greater velocity than the victim.

15. A computer program product comprising a computer usable medium having computer usable program code for identifying predatory patterns based on received positional information from the predator and the victim, the computer program product including:
computer usable program code for identifying correlations between position and movement of the predator and the victim; and
computer usable program code for determining the existence of one or more predatory patterns based upon the correlations.

16. The computer program product of claim 15, wherein the positional information includes at least the direction of movement, and the velocity of the predator and the victim, and the relational positioning between the predator and the victim.

17. The computer program product of claim 16, further comprising computer usable program code for determining the existence of an accidental encounter, wherein an accidental encounter exists if:
the predator moves within a restricted distance of the victim;
there is no correlation between the direction of movement and the velocity of the predator and the direction of movement and the velocity of the victim; and
the predator is not near a geographic region or path known by the victim, whereby an accidental encounter does not give rise to a predatory pattern.

18. The computer program product of claim 16, further comprising computer usable program code for determining the existence of a surveillance pattern, wherein a surveillance pattern exists if there is a correlation between the direction of movement and velocity of the predator and the direction of movement and velocity of the victim even if the predator is not within a restricted distance of the victim.

19. The computer program product of claim 16, further comprising computer usable program code for determining the existence of an ambush pattern, wherein an ambush pattern exists if the predator is substantially stationary for an extended period of time with respect to a geographic region or path known by the victim.

20. The computer program product of claim 16, further comprising computer usable program code for determining the existence of an attack pattern, wherein an attack pattern exists if the distance between the predator and the victim is less than a pre-determined distance and is decreasing with time, and the predator is moving with a greater velocity than the victim.
